(19) United States
(12) Patent Application Publication
(10) Pub. No.: US 2016/0177902 A1
(43) Pub. Date: Jun. 23, 2016

(54) FUEL UNIT PUMP AND INTERNAL COMBUSTION ENGINE COMPRISING IT

(71) Applicant: GM GLOBAL TECHNOLOGY OPERATIONS LLC, Detroit, MI (US)

(72) Inventor: Richard FRANK, Torino (IT)

(73) Assignee: GM GLOBAL TECHNOLOGY OPERATIONS LLC, Detroit, MI (US)

(21) Appl. No.: 14/976,589

(22) Filed: Dec. 21, 2015

(30) Foreign Application Priority Data
Dec. 22, 2014 (GB) 1423072.6

(51) Int. Cl. F02M 59/10

(52) U.S. Cl. CPC F02M 59/102

(57) ABSTRACT

A fuel unit pump for an internal combustion engine, said fuel unit pump comprising a fuel unit pump body, a pumping plunger and a follower assembly for following the movement of a cam lobe of a camshaft of the internal combustion engine. The follower assembly may have a follower body connected to the pumping plunger and a roller rotatably mounted on a roller carrier and having a roller rotation axis, wherein said roller carrier is rotatably mounted on said follower body and having a roller carrier rotation axis.

### CROSS-REFERENCE TO RELATED APPLICATION

This application claims priority to Great Britain Patent Application No. 1423072.6, filed Dec. 22, 2014, which is incorporated herein by reference in its entirety.

### TECHNICAL FIELD

The present disclosure pertains to the fuel injection of an internal combustion engine, and in particular to a fuel unit pump of an internal combustion engine.

### BACKGROUND

According to a possible configuration of the internal combustion engine injection system, a fuel unit pump is provided in order to supply fuel under pressure to the fuel injectors (injector nozzle).

This injection system is used for example in high-pressure injection system of diesel internal combustion engine.

The fuel unit pump is actuated by a correspondent cam lobe of the camshaft. More in detail, the fuel unit pump is provided with a follower assembly that is contacted by the camshaft. The follower assembly is connected to a pumping plunger so that the rotary movement of the camshaft can be transmitted to the fuel unit pump, and in particular to the pumping plunger of the fuel unit pump actuated by the contact of the follower assembly with the cam lobe of the camshaft.

In fact, the follower assembly is provided with a roller having a rotation axis arranged perpendicularly to the longitudinal movement direction of the pumping plunger.

The roller is contacted by the cam lobe(s) of the camshaft, so that the rotary movement of the camshaft can be transformed in a linear movement of the follower assembly and thus of the pumping plunger of the fuel unit pump, connected thereto. The fuel unit pump is fluidly connected to the fuel injectors, preferably by means of a fuel rail, to supply fuel in the engine cylinder.

However, a very high precision is required to assure that when the fuel unit pump is mounted in the internal combustion engine, preferably in the cylinder head of the internal combustion engine, the follower assembly, and in particular the roller of the follower assembly, is correctly aligned with respect to the camshaft, i.e. that the axis of rotation of the roller is exactly parallel to the camshaft.

Additionally, it is preferred that the pumping plunger, connected to the follower assembly, is exactly perpendicular to the camshaft. With the current manufacturing capability for controlling perpendicularity, very high hertzian stresses limit the injection pump capacity in terms of pressure and flow. In fact, if the pumping plunger, and thus the follower assembly comprising the roller, is not perpendicularly arranged with respect to the camshaft, and in particular with respect to the cam lobe, high stress between the roller and the cam lobe are generated, thus limiting injection capacity of the fuel unit pump.

In accordance with herein described embodiments of the present invention provided is a fuel unit pump allowing to increase the fuel injection pressure and/or flow capabilities.

In accordance with a further aspects of the present invention the manufacturing costs of the internal combustion engine may be reduced.

### SUMMARY

A fuel unit pump for an internal combustion engine may have a fuel unit pump body, a pumping plunger and a follower assembly for following the movement of a cam lobe of a camshaft of the internal combustion engine. The follower assembly may have a follower body, connected to the pumping plunger, and a roller rotatably mounted on a roller carrier and having a roller rotation axis, the roller carrier being rotatably mounted on the follower body and having a roller carrier rotation axis.

An advantage of the present solution is that the roller carrier can rotate with respect to the follower body. As a result, the roller, mounted on the roller carrier, can be aligned with respect to the camshaft.

Advantageously, the roller rotation axis can be tilted so that it is parallel to the axis of rotation of the camshaft. As a result, the correct coupling between the cam lobes of the camshaft and the roller of the follower assembly is achieved.

Moreover, it is possible to manufacture the internal combustion engine with wider tolerances in the alignment of fuel unit pump, and in particular of the follower assembly connected to pumping plunger, with respect to the camshaft. Possible misalignments are in fact compensated by the rotation of the roller carrier with respect to the follower body. As a result, in the present invention, the use of the fuel unit pump in an internal combustion engine makes the manufacture of the internal combustion engine cheaper.

According to a further herein described embodiment, the roller carrier rotation axis is perpendicular to a longitudinal movement direction, along which the pumping plunger, and thus also the follower assembly connected thereto, is movable.

This solution provides for an efficient rotation movement of the roller carrier with respect to the follower body and thus an efficient tilting movement of the roller rotation axis, which can be advantageously aligned with the cam lobe and in particular with the camshaft rotation axis.

According to a herein described embodiment, the roller carrier rotation axis and the roller rotation axis do not intersect each other. In other words, according to such an embodiment, the roller rotation axis is arranged at a distance from the roller carrier rotation axis. An advantage of this embodiments is that the rotation of the roller carrier with respect to the follower body allows a tilting movement of the roller rotation axis which can be advantageously aligned with the cam lobe and in particular with the camshaft rotation axis.

According to another herein described embodiment, the roller rotation axis, i.e. the axis around which the roller is rotatable with respect to the roller carrier, lies on a plane that is perpendicular to the roller carrier rotation axis. Advantageously, the rotation movement of the roller carrier around the roller carrier rotation axis, determines a tilting movement of the roller rotation axis in a plane that is perpendicular to the roller carrier rotation axis.

According to another herein described embodiment, the longitudinal movement direction along which the pumping plunger is movable lies on the plane, on which the roller rotation axis lies, and that is perpendicular to the roller carrier rotation axis. An advantage of this embodiment is to increase the robustness of the follower assembly of the fuel unit pump by allowing the tilting movement of the roller rotation axis, due to the rotation of the roller carrier around the roller carrier rotation axis, in a plane on which also the longitudinal movement direction of the pumping plunger lies.

According to another herein described embodiment, the roller carrier is rotatably mounted on the follower body by at least one pivot. An advantage of this embodiment is to provide a simple connection between the roller carrier and the follower body.

According to another herein described embodiment, the roller carrier and follower body are provided with at least one pivot seat, and the pivot is at least in part inserted into said pivot seat.

In other words, the pivot(s) is an element that is external to the roller carrier. This allows for a robust and effective connection between the follower body and the roller carrier.

According to another herein described embodiment of the invention, the pivot seat of the roller carrier is a through hole. An advantage is to provide robust and effective connection between the follower body and the roller carrier.

According to still another herein described embodiment of the invention the follower body may have two pivot seats for the ends of the pivot. An advantage of this embodiment is to firmly support the pivot so as to provide a robust connection between the follower body and the roller carrier.

According to another herein described embodiment, the follower body may have at least one lateral wall and the at least one seat of the follower body is arranged on the at least one lateral wall. An advantage of this embodiment is to limit the weight of the component while allowing a robust connection between the follower body and the roller carrier.

Another herein described embodiment of the present invention provides an internal combustion engine comprising a fuel unit pump according to the invention having one or more of the aspects and features disclosed herein with reference to the fuel unit pump. The internal combustion engine further may have a camshaft, rotatable around a camshaft rotation axis, and provided with at least one cam lobe. The roller of the fuel unit pump is coupled to the at least one cam lobe to transmit the rotary movement of the camshaft to the fuel unit pump, and in particular to the pumping plunger by the follower assembly, to actuate the fuel unit pump.

According to another herein described embodiment, the camshaft rotation axis is parallel to the rotation axis of said roller (roller rotation axis). This alignment allows a good cooperation between the cam lobes of the camshaft and the roller of the fuel unit pump.

### BRIEF DESCRIPTION OF THE DRAWINGS

The present invention will hereinafter be described in conjunction with the following drawing figures, wherein like numerals denote like elements.

FIG. 1 shows a possible embodiment of an automotive system comprising an internal combustion engine in which the fuel unit pump can be used;

FIG. 2 is a cross-section according to the plane A-A of an internal combustion engine belonging to the automotive system of FIG. 1;

FIG. 3 is a perspective and schematic view of a fuel unit pump according to an embodiment of the present invention coupled to a camshaft of an internal combustion engine;

FIG. 4 is an enlarged perspective view of the follower assembly of the fuel unit pump according to an embodiment of the present invention;

FIG. 5 is a partial, schematic and sectional view (taken on a plane perpendicular to the roller carrier rotation axis and on which the roller rotation axis and the longitudinal movement direction of the pumping plunger lie) of a fuel unit pump according to an embodiment of the present invention coupled to a camshaft of an internal combustion engine.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

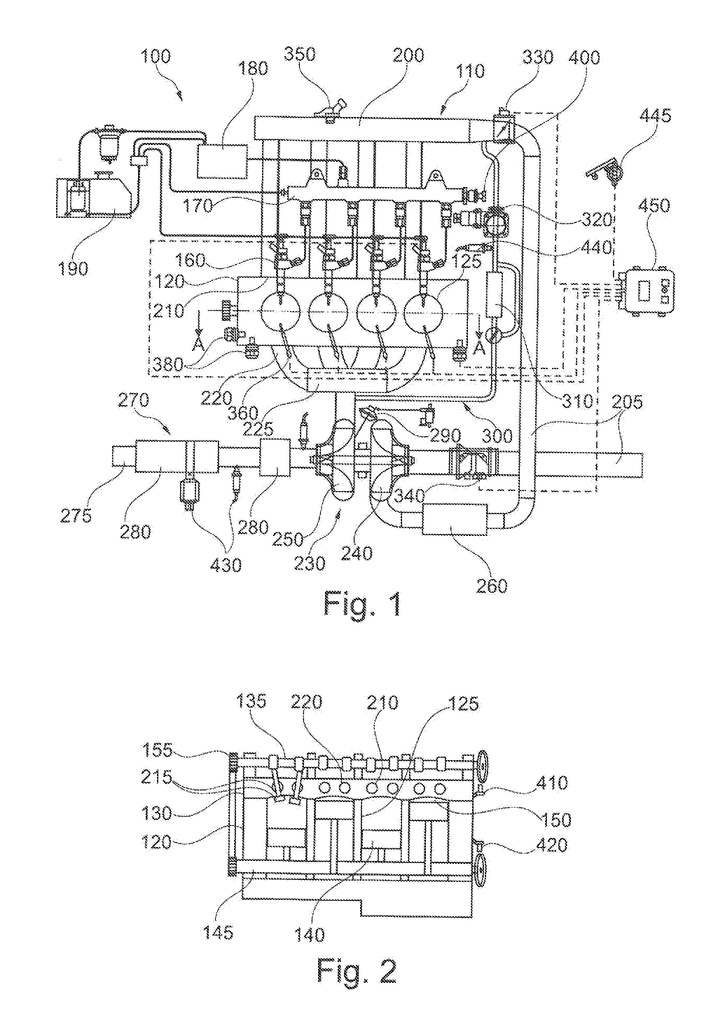

Some embodiments may include an automotive system 100, as shown in FIGS. 1 and 2, that includes an internal combustion engine (ICE) 110 having an engine block 120 defining at least one cylinder 125 having a piston 140 coupled to rotate a crankshaft 145. A cylinder head 130 cooperates with the piston 140 to define a combustion chamber 150. A fuel and air mixture (not shown) is disposed in the combustion chamber 150 and ignited, resulting in hot expanding exhaust gasses causing reciprocal movement of the piston 140. The fuel is provided by at least one fuel injector 160 and the air through at least one intake port 210. The fuel is provided at high pressure to the fuel injector 160 from a fuel rail 170 in fluid communication with a high pressure fuel pump that increases the pressure of the fuel received from a fuel source 190. According to a possible embodiment, the engine may have a fuel unit pump 180 that is actuated by the rotation of a camshaft 135. Each of the cylinders 125 has at least two valves 215, actuated by the camshaft 135 rotating in time with the crankshaft 145. The valves 215 selectively allow air into the combustion chamber 150 from the port 210 and alternately allow exhaust gases to exit through a port 220. In some examples, a cam phaser 155 may selectively vary the timing between the camshaft 135 and the crankshaft 145.

The air may be distributed to the air intake port(s) 210 through an intake manifold 200. An air intake duct 205 may provide air from the ambient environment to the intake manifold 200. In other embodiments, a throttle body 330 may be provided to regulate the flow of air into the manifold 200. In still other embodiments, a forced air system such as a turbocharger 230, having a compressor 240 rotationally coupled to a turbine 250, may be provided. Rotation of the compressor 240 increases the pressure and temperature of the air in the duct 205 and manifold 200. An intercooler 260 disposed in the duct 205 may reduce the temperature of the air. The turbine 250 rotates by receiving exhaust gases from an exhaust manifold 225 that directs exhaust gases from the exhaust ports 220 and through a series of vanes prior to expansion through the turbine 250. The exhaust gases exit the turbine 250 and are directed into an exhaust system 270. This example shows a variable geometry turbine (VGT) with a VGT actuator 290 arranged to move the vanes to alter the flow of the exhaust gases through the turbine 250. In other embodiments, the turbocharger 230 may be fixed geometry and/or include a waste gate.

The exhaust system 270 may include an exhaust pipe 275 having one or more exhaust aftertreatment devices 280. The aftertreatment devices may be any device configured to change the composition of the exhaust gases. Some examples of aftertreatment devices 280 include, but are not limited to, catalytic converters (two and three way), oxidation catalysts, lean NOx traps, hydrocarbon adsorbers, selective catalytic reduction (SCR) systems, and particulate filters. Other embodiments may include an exhaust gas recirculation (EGR) system 300 coupled between the exhaust manifold 225 and the intake manifold 200. The EGR system 300 may include an EGR cooler 310 to reduce the temperature of the exhaust gases in the EGR system 300. An EGR valve 320 regulates a flow of exhaust gases in the EGR system 300.

The automotive system 100 may further include an electronic control unit (ECU) 450 in communication with one or more sensors and/or devices associated with the ICE 110. The ECU 450 may receive input signals from various sensors configured to generate the signals in proportion to various physical parameters associated with the ICE 110. The sensors include, but are not limited to, a mass airflow and temperature sensor 340, a manifold pressure and temperature sensor 350, a combustion pressure sensor 360, coolant and oil temperature and level sensors 380, a fuel rail pressure sensor 400, a cam position sensor 410, a crank position sensor 420, exhaust pressure and temperature sensors 430, an EGR temperature sensor 440, and an accelerator pedal position sensor 445. Furthermore, the ECU 450 may generate output signals to various control devices that are arranged to control the operation of the ICE 110, including, but not limited to, the fuel unit pump 180, fuel injectors 160, the throttle body 330, the EGR Valve 320, the VGT actuator 290, and the cam phaser 155. Note, dashed lines are used to indicate communication between the ECU 450 and the various sensors and devices, but some are omitted for clarity.

Turning now to the ECU 450, this apparatus may include a digital central processing unit (CPU) in communication with a memory system, or data carrier, and an interface bus. The CPU is configured to execute instructions stored as a program in the memory system, and send and receive signals to/from the interface bus. The memory system may include various storage types including optical storage, magnetic storage, solid state storage, and other non-volatile memory. The interface bus may be configured to send, receive, and modulate analog and/or digital signals to/from the various sensors and control devices.

Instead of an ECU 450, the automotive system 100 may have a different type of processor to provide the electronic logic, e.g. an embedded controller, an onboard computer, or any processing module that might be deployed in the vehicle.

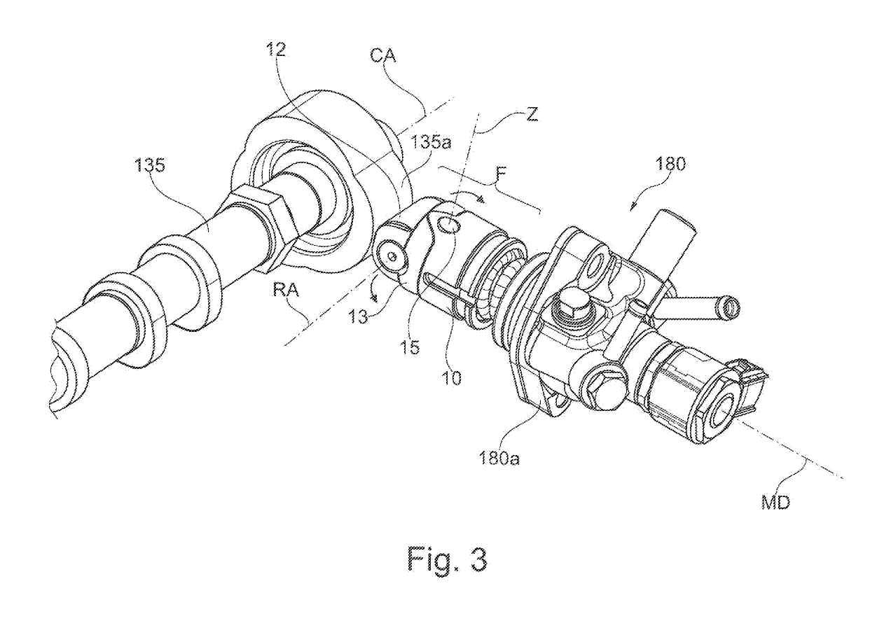

According to an embodiment of the invention, as shown in FIGS. 3-5, the fuel unit pump 180 may have a fuel unit pump body 180a and a pumping plunger 180b. The pumping plunger is arranged at least in part within said fuel unit pump body 180a.

The pumping plunger 180b is movable along a longitudinal movement direction MD. More in detail, the pumping plunger 180b is movable with respect to fuel unit pump body 180a, preferably inside a chamber (not shown) provided inside the fuel unit pump body 180a.

The longitudinal movement direction MD of the pumping plunger 180b preferably corresponds to the longitudinal axis of the pumping plunger 180b.

The pumping plunger 180b is movable along a longitudinal movement direction MD, for drawing fuel from the fuel source and for pressurizing it before the delivery outside the fuel unit pump, for example to a fuel injector 160.

In fact, according to a possible embodiment, in the internal combustion engine 110 in which the fuel unit pump 180 can be used, the fuel unit pump 180 is connected to a fuel source 190, from which the fuel is provided. The fuel unit pump 180 is connected to one or more fuel injectors 160 (injector nozzle), preferably by a fuel rail 170.

For this purpose the fuel unit pump 180 is provided with a fuel inlet opening and a fuel outlet opening provided on the body 180a of the fuel unit pump, and fluidically connected to the chamber provided therein, inside which the pumping plunger 180b is moveable.

More in detail, the fuel is supplied to the fuel injector 160 from the fuel unit pump 180 due to a pumping movement of the pumping plunger 180b along the longitudinal movement direction MD. In fact, the pumping plunger 180b is movable along longitudinal movement direction MD between a non-operative position (preferably corresponding to a non-pumping position), in which it is extracted from the body of the fuel unit pump, and in particular from a chamber provided therein, and an operative position (preferably corresponding to a pumping position) in which it is moved inside the fuel unit pump body.

Returning means 180c, for example comprising at least one spring or other elastic means, can be provided to maintain the pumping plunger 180b in the non-operative position.

The fuel unit pump 180 also may have a follower assembly (generally indicted with the reference F, see in particular FIG. 3) having a follower body 10, connected to the pumping plunger 180b, and a roller 12 rotatably mounted on a roller carrier 13 and having a roller rotation axis RA. The roller carrier 13 is rotatably mounted on the follower body 10 and is provided with a roller carrier rotation axis Z, so as to allow the rotation of the roller carrier 13 with respect to the follower body 10 around the roller carrier rotation axis Z.

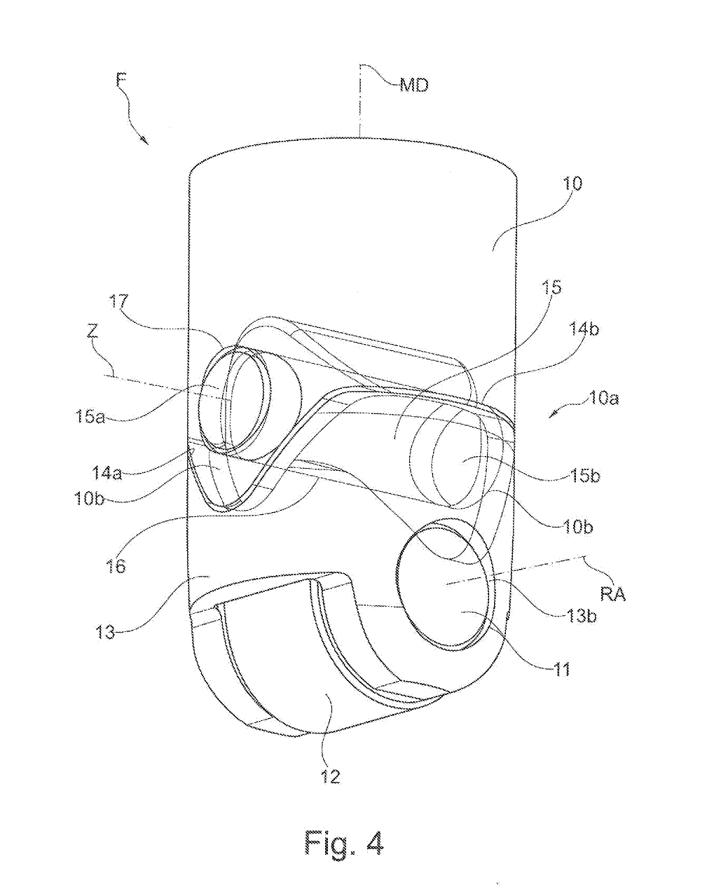

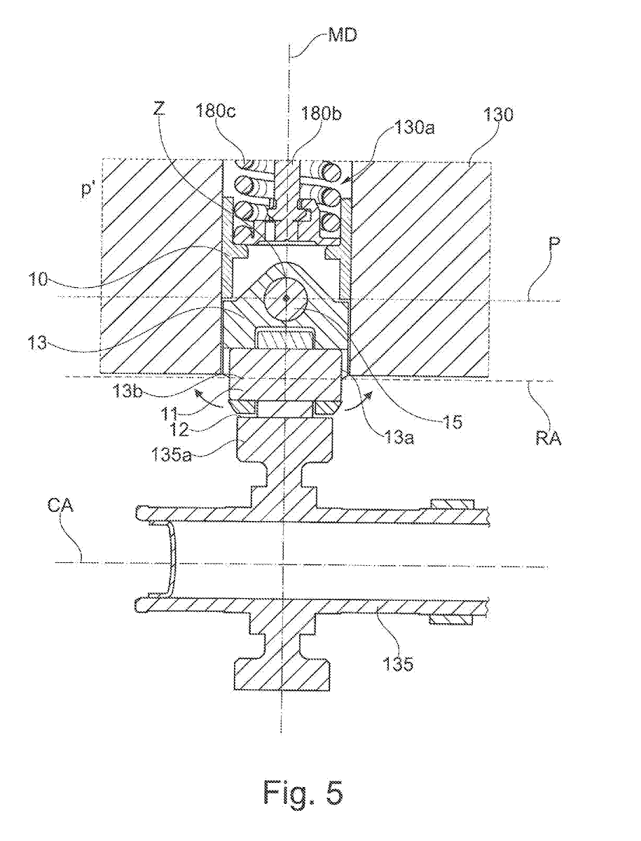

It has to be noted that the expression “follower body connected to the pumping plunger” is used herein to indicate that the follower body 10 is constrained to the pumping plunger 180b (as for example shown in the attached FIG. 4-5, wherein the follower body is constrained to an end portion of the pumping plunger) and also that the follower body 10 can be made in one piece (made integral) with the pumping plunger 180b.

The follower assembly F is movable with the pumping plunger 180b in the longitudinal movement direction MD. As for example shown in the figures, the longitudinal movement direction MD is a movement along a straight line, preferably a reciprocating movement along the longitudinal movement direction MD.

The pumping plunger 180b of the fuel unit pump 180, connected to the follower assembly F, is actuated along the longitudinal movement direction MD to reach an operative position, by means of the camshaft 135, and in particular by at least one cam lobe 135a of the camshaft. More in detail, the roller 12 mounted on the roller carrier 13, which in turn is rotatably mounted on the follower body 10, engages the cam lobe(s) 135a of the camshaft in order to actuate the fuel unit pump.

According to an embodiment, as for example shown in the figures, the roller carrier 13 and the follower body 10 have a substantially cylindrical shape. However, different shapes of one of these components, or of both these components, can be provided. According to a possible embodiment, the roller carrier 13 is provided with a slightly reduced cross section with respect to the follower body 10 so as to allow the rotation of the roller carrier 13 with respect to the follower body 10 around the roller carrier rotation axis Z when the fuel unit pump 180, and in particular the follower assembly F, is installed in the cylinder head 130 and in particular in a hole 130a of the cylinder head 130 (see FIG. 5). More in detail, according to a possible embodiment, as for example shown in FIG. 5, the roller carrier 13 is substantially cylindrically shaped and it is provided with a slightly reduced diameter with respect to the follower body 10, that is also substantially cylindrically shaped.

As mentioned above, the roller 12 is rotatably mounted on the roller carrier 13. In more detail, the roller 12 is rotatable with respect to the roller carrier 13 around the roller rotation axis RA.

In the shown embodiment, the roller 12 is provided with a pin 11. The pin 11 is rotatably inserted in corresponding seats 13a, 13b of the roller carrier 13.

The roller 12 is preferably provided with a cylindrical shape, thus providing a flat lateral surface that is intended to contact the cam lobe 135a of the camshaft 135 of the internal combustion engine 110 (see for example FIGS. 3 and 5).

In different embodiments, not shown, the coupling between the roller 12 and the roller carrier 13 may be by different means. As an example, in an embodiment, the roller carrier 13 may be provided with cylindrical protrusions, and the roller may be provided with cylindrical seats for these protrusions.

In general, the roller 12 is rotatably mounted on the roller carrier 13 so that the roller can be rotated around a roller rotation axis RA.

As mentioned above, the roller carrier 13 is in turn rotatably mounted on the follower body 10, preferably at an end portion 10a of the follower body 10. The roller carrier 13 is provided with a roller carrier rotation axis Z, so that it is rotatable with respect to the follower body 10 around the roller carrier rotation axis Z. In an embodiment, the roller carrier rotation axis Z is perpendicular to the longitudinal movement direction MD of the follower body 10 and in general of the pumping plunger 180b.

In an embodiment, the roller carrier rotation axis Z is perpendicular to the rotation axis RA. In further detail, it should be noted that the roller carrier rotation axis Z and the roller rotation axis RA do not intersect each other (i.e. the roller rotation axis RA and the roller carrier rotation axis Z are arranged at a distance one with respect to another). In this case, with the wording “perpendicular” it is meant that the two axis (Z and RA) are perpendicular when they are projected on the same plane P, and in particular when the roller rotation axis RA is projected on a plane P comprising the roller carrier rotation axis Z (i.e. a plane on which the roller carrier rotation axis Z lies), and parallel to the rotation axis RA. In other words, the projection of the roller rotation axis RA on a plane P, comprising the roller carrier rotation axis Z and parallel to the roller rotation axis RA, is perpendicular to the roller carrier rotation axis Z.

It has to be noted that, according to an embodiment, the roller rotation axis RA and the roller carrier rotation axis Z are arranged one with respect to another of an angle of 90°, even if the axes RA and Z do not intersect to each other.

In the shown embodiment, the roller carrier rotation axis Z is perpendicular to both the longitudinal movement direction MD and the rotation axis RA.

It has to be noted that, according to an embodiment, the three axes RA, Z and MD are arranged one with respect to another at an angle of 90°, even if all the axes RA, Z and MD do not intersect to each other in a single point.

According to an embodiment, the roller rotation axis RA lies on a plane P′, that for example in FIG. 5 is the plane along which the section view is taken, and the plane P′ is perpendicular to the roller carrier rotation axis Z. When the roller carrier 13 rotates with respect to the follower body 10 around the roller carrier rotation axis Z, the roller rotation axis RA of the roller 12 is tilted in the plane P′.

It has to be noted that, as for example visible in FIG. 5, the longitudinal movement direction MD of the pumping plunger (180b) and thus of the follower assembly F connected to it, lies on the plane P′, i.e. the plane on which the roller rotation axis RA lies and that is perpendicular to the roller carrier rotation axis Z.

According to an embodiment, the camshaft rotation axis CA lies on the plane P′ on which the roller rotation axis RA lies and that is perpendicular to the roller carrier rotation axis Z (see for example FIG. 5).

As mentioned above, the rotation of the roller carrier 13 around the roller carrier rotation axis Z causes a tilting of the rotation axis RA of the roller 12. This tilting movement provides for an efficient alignment between the roller rotation axis RA of the roller with the camshaft 135.

In an embodiment, the rotation of the roller carrier 13 with respect to the follower body 10 is limited to few degrees. According to a possible embodiment, the rotation of the roller carrier 13 with respect to the follower body 10 is equal to, or below one degree. According to another possible embodiment, the rotation of the roller carrier 13 with respect to the follower body 10 may be in the range 0.3-0.6 degree.

As a result, in operative condition, the roller rotation axis RA can be perpendicular to the longitudinal movement direction MD of the follower body 10 (and in general of the pumping plunger 180b), or it can be inclined by few degrees with respect to an axis perpendicular to said longitudinal movement direction MD.

According to a possible embodiment, as for example shown in FIG. 4, the follower body 10 is provided with stop surfaces 14a, 14b that may engage the roller carrier 13 to limit the rotation of the roller carrier 13 itself around the axis Z. In other words, the stop surfaces 14a, 14b define the ends of the angular run of the roller carrier 13 around the roller carrier rotation axis Z.

According to a possible embodiment, as for example shown in the figures, the roller carrier 13 is rotatably mounted on the follower body 10 by means of a pivot 15, e.g. a rod, or a pin, or a shaft, preferably made of metal. According to a possible embodiment, as for example shown in the figures, the roller carrier rotation axis Z corresponds to the longitudinal axis of the at least one pivot 15.

The roller carrier 13 and/or the follower body 10 can be provided with at least one pivot seat 16, 17, where the pivot 15 is at least in part inserted. The follower body 10 and the roller carrier 13 are arranged so that the at least one seat 16 of the follower body 10 and the at least one seat 17 of the roller carrier 13 are aligned. By doing so, the pivot 15 can be arranged in the seats 16, 17 to allow the rotation of the roller carrier 13 with respect to the follower body 10.

According to an embodiment, the pivot seat 16 of the roller carrier 13 may have a hole, and preferably a through hole passing through the roller carrier 13 (e.g. a hole that crosses the roller carrier). According to an embodiment, the through hole 16 provides two openings on a lateral surface of the roller carrier 13, inside which the pivot 15 is inserted.

According to a possible embodiment, as for example shown in FIG. 4, the seat 17 of the follower body 10 for the pivot 15 may have at least one seat (e.g. a hole), preferably arranged on a lateral wall 10b, 10c of the follower body 10.

In fact, the follower body 10 can be at least one lateral wall 10b, 10c, and the at least one seat 17 is arranged on the at least one lateral wall 10b, 10c. As for example shown in FIG. 4, two lateral walls 10b, 10c, leaving a space there between for the arrangement of at least part of the roller carrier 13, can be provided on the follower body 10.

The roller carrier 13 and the follower body 10 are arranged so that the hole 16 of the roller carrier 13 and the seats (holes) 17, arranged on the lateral walls 10b, 10c of the follower body 10, are aligned thus allowing the passage of the pivot 15.

In general, according to an embodiment, the follower body 10 may have two pivot seats 17, for example two holes, to receive the ends 15a, 15b of the pivot 15.

According to an embodiment, the pivot 15 is freely inserted in both the follower body 10 and the roller carrier 13, and in particular in the correspondent seats 16, 17 provided thereon.

Alternatively, in other embodiments, a plurality of pivots 15 (and thus of relevant pivot seats) may be provided to mount the roller carrier 13 on the follower body 10 in a rotatable manner. According to these embodiments, the pivots 15 are aligned along the same axis, i.e. the roller carrier rotation axis Z, in order to allow the rotation of the roller carrier 13 around the roller carrier rotation axis Z with respect to the follower body 10.

In further embodiments, one element chosen between the roller carrier 13 and the follower body 10 may be provided with one or more protrusions (preferably cylindrical), for example a pivot constrained to one of these elements (13, 10), that may be inserted in a rotatable manner into relevant seats of the other element, to provide a rotation of the roller carrier 13 with respect to the follower body 10 around the axis Z.

During operation of the internal combustion engine 110, the camshaft 135 rotates around a camshaft rotation axis CA. It has to be noted that preferably the camshaft rotation axis corresponds to the extension (longitudinal) axis of the camshaft.

The roller 12 is coupled to the camshaft 135 and in particular with the cam lobe(s) 135a of the camshaft 135. As known in the art, the fuel unit pump 180 is arranged on the engine, preferably in correspondence of the cylinder head 130 (for example shown in FIG. 1 and in FIG. 5). The follower assembly F and in particular the roller 12, the roller carrier 13 and the follower body 10 are arranged in a seat, e.g. a hole 130a, of the internal combustion engine 110, and in particular of the cylinder head 130, inside which these elements are movable (as for example schematically shown in FIG. 5).

The seat inside which the follower assembly F is movable (see for example FIG. 5) is shaped as a hole 130a, preferably having a constant diameter. As mentioned above, the roller carrier 13 is provided with a slightly reduced cross section with respect to the follower body 10, and also with respect to the seat (hole 130a) of the cylinder head 130, so as to allow the rotation of the roller carrier 13 with respect to the follower body 10, around the roller carrier rotation axis Z, inside the hole 130a of the cylinder head 130.

More in detail, the follower body 10 is preferably provided with a cross section dimension substantially corresponding to the cross section dimension of the seat of the cylinder head inside which the follower assembly F is arranged. Preferably, the follower body 10 has a diameter substantially corresponding to the diameter of the hole 130a of the cylinder head 130 so as to allow the movement along the longitudinal movement direction MD. The roller carrier 13 has a slightly reduced cross section dimension, e.g. a slightly reduced diameter, with respect to the hole 130a of the cylinder head, so as to allow a rotation around the roller carrier rotation axis Z.

As mentioned above, the follower assembly F follows the movement of at least one cam lobe 135a of a camshaft 135 of the internal combustion engine 110.

The coupling between the roller 12 and the camshaft 135 causes the rotation of the roller carrier 13 around roller carrier rotation axis Z in the case the perpendicularity between the pumping plunger 180b (and thus of the follower assembly F), and the camshaft is not respected.

More in detail, if the movement direction of the follower assembly, preferably corresponding to the longitudinal movement direction MD of the pumping plunger 180b to which is connected, is not perpendicular to the camshaft rotation axis CA, the roller carrier 13 rotates with respect to the follower body 10 around the rotation axis Z.

By doing so, the rotation axis RA of the roller 12 is tilted so as to be parallel to the camshaft rotation axis CA. This allows an efficient transmission of the rotary movement of the camshaft to the pumping plunger 180b by means of the follower assembly F of the fuel unit pump 180, without increasing contact stresses between the roller 12 and the cam lobe 135a of the camshaft 135.

Moreover, the rotation of the camshaft 135, and thus of the cam lobe(s) 135a, causes the reciprocation of the follower assembly F and thus of the pumping plunger 180b along the longitudinal movement direction MD. As before explained, this alternate movement allows pumping of fuel to the injectors 160.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-12. (canceled)

13. A fuel unit pump for an internal combustion engine, said fuel unit pump comprising a fuel unit pump body, a pumping plunger and a follower assembly (F) for following the movement of a cam lobe of a camshaft of the internal combustion engine, the follower assembly comprising a follower body, connected to said pumping plunger, and a roller rotatably mounted on a roller carrier and having a roller rotation axis (RA), wherein said roller carrier is rotatably mounted on said follower body and having a roller carrier rotation axis (Z).

14. The fuel unit pump according to claim 13, wherein the pumping plunger is movable along a longitudinal movement direction (MD) and the roller carrier rotation axis (Z) is perpendicular to said longitudinal movement direction (MD) of the pumping plunger.

15. The fuel unit pump according to claim 13, wherein the roller carrier rotation axis (Z) and the roller rotation axis (RA) do not intersect each other.

16. The fuel unit pump according to claim 13, wherein said roller rotation axis (RA) lies on a plane (P′) perpendicular to the roller carrier rotation axis (Z).

17. The fuel unit pump according to claim 16, wherein the pumping plunger is movable along a longitudinal movement direction (MD) and said longitudinal movement direction (MD) lies on said plane (P′).

18. The fuel unit pump according to claim 16, wherein said roller carrier is rotatably mounted on said follower body by at least one pivot.

19. The fuel unit pump according to claim 18, wherein said roller carrier and said follower body are provided with at least one pivot seat, and said pivot is inserted into said pivot seat.

20. The fuel unit pump according to claim 19, wherein said pivot seat of the roller carrier is a through hole.

21. The fuel unit pump according to claim 19, wherein said follower body comprises two pivot seats for the ends of said pivot.

22. The fuel unit pump according to any claim 19, wherein said follower body comprises at least one lateral wall, and said at least one seat of the follower body is arranged on said at least one lateral wall.

23. Internal combustion engine comprising a fuel unit pump according to claim 13, a camshaft provided with at least one cam lobe and rotatable around a camshaft rotation axis (CA), wherein said roller of said fuel unit pump is coupled to said at least one cam lobe to transmit the rotary movement of the camshaft to the fuel unit pump, to actuate it.

24. Internal combustion engine according to claim 23, wherein said camshaft rotation axis (CA) is parallel to said roller rotation axis (RA).
